(19) United States
(12) Patent Application Publication
(10) Pub. No.: US 2010/0182632 A1
(43) Pub. Date: Jul. 22, 2010

(54) PRINT SYSTEM AND METHOD

(75) Inventors: YI-FANG WU, Tu-Cheng (TW); YONG-HUI XIAO, Shenzhen City (CN); WEN-YI WU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/548,086

(22) Filed: Aug. 26, 2009

(30) Foreign Application Priority Data
Jan. 16, 2009 (CN) 200910300223.9

(51) Int. Cl. G06F 3/12

(52) U.S. Cl. 358/1.15

(57) ABSTRACT

A print system includes a relay service system. The relay service system includes a mail server and a print server. The mail server is capable of receiving an e-mail, and extracting a file needed to be printed from the e-mail. The print server is capable of controlling a plurality of printers and printing the file.

### BACKGROUND

1. Technical Field

The present embodiment relates to print systems and methods, and particularly to a print system and method using e-mail.

2. Description of Related Art

In conventional, a terminal, which has a printer driver installed, sends files to a corresponding printer to print. However, if there is a plurality of terminals having a need to print, each of the terminals are required to have the driver of the corresponding printer installed. In another aspect, if a terminal needs to connect to different printers for printing files, the terminal should have several different drivers of the different printers. It can be a burden to install so many drivers of different printers on different terminals. Additionally, when some portable terminals, such as laptop computers, smart phones, and so on, are moved to a new work environment, these portable terminals often need to connect to a new printer, which can be troublesome particularly if the driver is not readily available.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block view of a print system; and

FIG. 2 is a flow chart of a print method.

### DETAILED DESCRIPTION

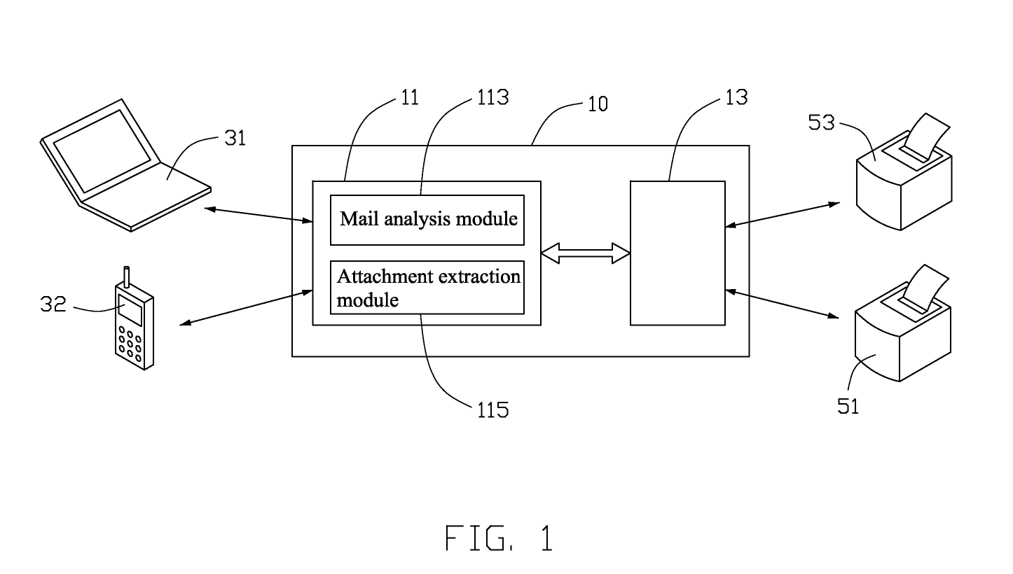

Referring to FIG. 1, a print system includes a plurality of terminals having the need to print, a relay service system 10, a first printer 51, and a second printer 53. In one embodiment, the plurality of terminals includes a laptop computer 31 and/or a smart phone 32. Both the laptop computer 31 and the smart phone 32 can send e-mail. The first printer 51 can be a laser printer, and the second printer 53 can be an inkjet printer.

The relay service system 10 includes a mail server 11, and a print server 13. The mail server 11 and the print server 13 are in communication with each other. The mail server 11 is capable of receiving e-mails sent from the terminals 31, 33. The mail server 11 includes a mail analysis module 113 and an attachment extraction module 115. The plurality of terminals 31, 33 send print setup information, and the file needed to be printed, to the mail server 11 by e-mail. For example, the file can be attached to the e-mail as an attachment of the e-mail. The print setup information is written in a text part of the e-mail in some pre-set format. After the mail server 13 receives the e-mail, the attachment extraction module 115 extracts the attachment of the e-mail as the file to be printed, and the mail analysis module 113 analyzes the text part of the mail obtaining the print setup information. The mail server 11 is capable of transmitting the print setup information and the attachment to the print server 13.

For example, the e-mail can be written in the following format: “printer: the first printer; print range: pages form 1 to 3; copies: 2”. In response to the e-mail, the mail analysis module 113 can get the print setup information that the first printer should be used to print two copies of each of pages 1, 2, and 3 of the attachment. The format can be altered as desired.

The printer server 13 is connected to the first printer 51 and the second printer 53. The printer server 13 has drivers of different printers installed therein, and can drive the printers 51, 53.

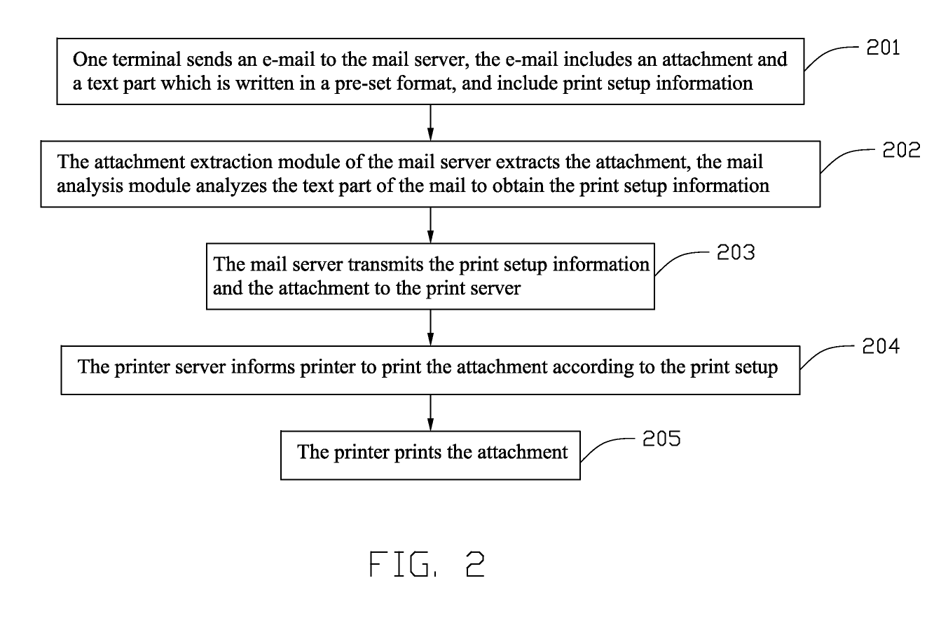

Referring to FIG. 2, a print method using the system of FIG. 1, is shown as follows:
In step 201, one terminal, such as the laptop computer 31 or the smart phone 32, sends an e-mail to the mail server 11 of the relay service system. The e-mail includes an attachment, which is the file to be printed, and a text part, which is written in the above format and includes the print setup information.
In step 202, the mail server 11 receives the e-mail. The attachment extraction module 115 extracts the file/attachment, and the mail analysis module 113 analyzes the text part of the mail to obtain the print setup information.
In step 203, the mail server 11 transmits the print setup information and the attachment to the print server 13.
In step 204, the printer server 13 informs the corresponding printer to print the attachment according to the print setup.
In step 205, the corresponding printer prints the attachment.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A print system, the print system comprising:
a relay service system, the relay service system comprising:
a mail server capable of receiving an e-mail, and extracting a file needed to be printed from the e-mail; and
a print server capable of controlling a plurality of printers and printing the file.

2. The print system of claim 1, wherein the mail server comprises an attachment extraction module capable of extracting the file from an attachment within the e-mail.

3. The print system of claim 1, wherein the e-mail comprises a text part which is written in a pre-set format to include print setup information, the mail server comprises a mail analysis capable of analyzing the text part of the mail and obtaining the print setup information.

4. The print system of claim 3, wherein the print setup information includes a printer, pages of the file need to be printed, how many copies needs to be printed, or a combination thereof.

5. The print system of claim 1, wherein the printer server has a plurality of printer drivers installed thereon.

6. A print method, comprising following steps:
a mail server receives an e-mail with a file attached as an attachment, extracts the file from the e-mail, and transmits the file to a print server;
the print server finds a designated printer according to the e-mail, and instructs the printer to print the file.

7. The print method of claim 6, wherein the e-mail comprises a text part which is written in a pre-set format to include print setup information; the mail server comprises a mail analysis module, the mail analysis module analyzes the text part of the mail, and retrieves the print setup information from the e-mail.

8. The print method of claim 7, wherein the print setup information includes which print is chosen from an identification of the printer to print, pages of the file to be printed, how many copies, or a combination thereof.

9. The print method of claim 6, wherein the mail server comprises an attachment extraction module that extracts the file from the attachment within the e-mail.
